(19) United States
(12) Patent Application Publication
(10) Pub. No.: US 2007/0104205 A1
(43) Pub. Date: May 10, 2007

(54) System and method for processing packet mobile-terminated calls using dynamic IP

(75) Inventor: Woon Song Baik, Anyang-si (KR)

Correspondence Address: KED & ASSOCIATES, LLP, P.O. Box 221200, Chantilly, VA, 20153-1200, US

(73) Assignee: LG-Nortel Co., Ltd.

(21) Appl. No.: 11/594,923

(22) Filed: Nov. 9, 2006

(30) Foreign Application Priority Data
Nov. 10, 2005 (KR) 10-2005-107621

(51) Int. Cl. H04L 12/56

(52) U.S. Cl. 370/395.3; 370/352; 370/401

(57) ABSTRACT

A system and method are provided for processing packet mobile-terminated calls from an Internet host to a mobile terminal in a radio packet service network. The system may include a DNS for processing a domain name conversion request from the Internet host, and a mobile-terminated server for retrieving information of a packet mobile-terminated subscriber by searching for dynamic subscriber information in a conversion DB. The mobile-terminated server may request initiation of packet mobile-terminated call connection and IP resolve, register assigned IP address and transmit the IP address to the DNS. A mobile-terminated GGSN may obtain address information of a SGSN to which the packet mobile-terminated subscriber belongs from a HLR and request initiation of the packet mobile-terminated call connection. A SGSN may request initiation of the packet mobile-terminated call connection, select the GGSN for establishing the packet mobile-terminated call and request establishment of a session connection for the packet mobile-terminated call connection. A GGSN may assign an IP address to the packet mobile-terminated subscriber, establish a session, transmit the assigned IP address to the mobile-terminated server and transmit user traffic received from the Internet host to the packet mobile-terminated subscriber through the SGSN and a base station.

This application claims priority from Korean Patent Application No. 10-2005-107621, filed Nov. 10, 2005, the subject matter of which is incorporated herein by reference.

### BACKGROUND

1. Field

Embodiments of the present invention may relate to a next-generation radio packet service network. More particularly, embodiments of the present invention may relate to a system and method for processing packet mobile-terminated calls using dynamic Internet Protocol (IP) in a next-generation radio packet mobile-terminated service network.

2. Background

FIG. 1 illustrates a system for processing packet mobile-terminated calls for a mobile terminal in a general packet radio service (GPRS) network according to an example arrangement. Other arrangements may also be used. More specifically, FIG. 1 shows that a system 100 for processing packet mobile-terminated calls may include a host 10, a Gateway GPRS Support Node (GSSN) 11, a Serving GPRS Support Node (SGSN) 12, a Home Location Register (HLR) 13, a base station 14 and a mobile terminal 15. While FIG. 1 only labels one mobile terminal 15, one base station 14 and one SGSN 12, other mobile terminals, base stations and/or SGSN are also shown.

The host 10 may transmit user data Packet Data Protocol (PDP) (e.g., IP) PDUs (Protocol Data Units) (i.e., user traffic through the Internet). The GGSN 11 may be a gateway for interaction between the GPRS network and the Internet. The SGSN 12 may perform packet switching. The HLR 13 may manage information of subscriptions and subscribers' locations. The base station 14 may transmit packet data to the mobile terminal 15 and manage radio resources. The mobile terminal 15 may be used by subscribers to receive a radio packet data service.

In a next-generation radio packet service network, the mobile terminal 15 may be provided with a packet mobile-terminated service using static IP. The GGSN 11 may act as a gateway to store and manage static subscriber information to store International Mobile System Identifier (IMSI) and Access Point Name (APN) information, which may be necessary to search for location information of the mobile terminal 15 of packet mobile-terminated subscribers (i.e., users of the terminals).

FIG. 2 illustrates processing operations of packet mobile-terminated calls using static IP in a next-generation radio packet service network according to an example arrangement. Other arrangements may also be used. The host 10 may transmit user data PDP PDU (i.e., user traffic) through the Internet to the GGSN 11 where the packet mobile-terminated subscriber 15 is located using a static IP address of the packet mobile-terminated subscriber 15. The GGSN 11 may determine whether there is information regarding the mobile subscriber session for the PDP address. If there is session information, then the GGSN 11 may encode the PDP PDU in a GPRS Tunneling Protocol-User Plain (GTP-U) format and transmit the encoded data to the SGSN 12 that provides packet service to the mobile terminal 15.

If there is no session information, then the GGSN 11 may search for static subscriber information managed by the GGSN 11 and determine whether a mobile-terminated call connection is to be tried. The GGSN 11 may use a mobile-terminated IP address, which is a PDP address of the PDP PDU, and may determine whether there is static subscriber information for the mobile-terminated IP address. When there is static subscriber information for the mobile-terminated IP address and a Mobile Not Reachable flag (MNRG) corresponding to the mobile-terminated IP address is Clear, then the GGSN 11 may retrieve IMSI information (i.e., identification information for the corresponding packet mobile-terminated subscriber 15). Then, the GGSN 11 may inquire about location information of the packet mobile-terminated subscriber by transmitting the retrieved IMSI information to the HLR 13 and receive address information of the SGSN 12 from the HLR 13 regarding where the packet mobile-terminated subscriber 15 is located.

Thereafter, by using the SGSN address information received from the HLR 13, the GGSN 11 may notify the corresponding SGSN 12 that there is a request for a mobile-terminated call connection to the corresponding packet mobile-terminated subscriber 15. At that time, the SGSN 12 may request a packet mobile-terminated call connection to the mobile terminal of the corresponding packet mobile-terminated subscriber 15 through the base station 14.

The packet mobile-terminated subscriber 15 requesting the packet mobile-terminated call connection may obtain GGSN address information from the HLR 13 through the SGSN 12 and may perform a procedure for call connection to the corresponding GGSN 11. From those procedures, a packet mobile-terminated call connection may be established. After establishment of the mobile-terminated call connection, the packet mobile-terminated subscriber 15 may receive user traffic PDP PDU from the host 10 through the Internet and the GPRS network.

In the next-generation radio packet service network, static IP may be assigned to individual mobile terminals to provide packet mobile-terminated call service when the mobile terminals subscribe to the packet mobile-terminated service. There is static subscriber information for the assigned IP in the GGSN. User data PDP PDU to be transmitted to the packet mobile-terminated service subscriber may be transmitted to the GGSN that has the corresponding static subscriber information.

In the next-generation radio packet service network, when the packet mobile-terminated service is intended to be provided using dynamic IP (not static IP), a sender may not know IP information for a corresponding service subscriber and therefore can not transmit PDP PDUs before a session is established. Even though one may know dynamic IP to be assigned to the corresponding service subscriber and GGSN information, it may be impossible, impractical or difficult to predict by which GGSN the mobile-terminated call is established since the GGSN trying mobile-terminated using dynamic IP may be different from the GGSN establishing actual connection. To request the SGSN to address the HLR, IMSI information (i.e., identification information for the packet mobile-terminated service subscriber) should be known. However, since identification for the subscriber is not static but rather is dynamic, it may be impossible, impractical or difficult to obtain the IMSI information with dynamic IP and provide packet service. As a result, there is a problem in that static IP should be used to provide packet mobile-terminated services. Due to the use of static IP, the IP resources may be inevitably dissipated. Thus, there are limits in providing the Internet service.

Further, in view of the service provider, management cost may become higher since static subscriber information for the packet mobile-terminated service subscriber should be managed in each GGSN.

### BRIEF DESCRIPTION OF THE DRAWINGS

Arrangements and embodiments may be described in detail with reference to the following drawings in which like reference numerals refer to like elements and wherein:

FIG. 1 illustrates a system for processing packet mobile-terminated calls in a next-generation radio packet service network according to an example arrangement;

FIG. 2 illustrates processing operations of packet mobile-terminated calls using static IP in a next-generation radio packet service network according to an example arrangement;

FIG. 3 illustrates a system for processing packet mobile-terminated calls using dynamic IP in a next-generation radio packet service network according to an example embodiment of the present invention;

FIGS. 4A and 4B illustrate a mobile-terminated GGSN and a GGSN according to an example embodiment of the present invention;

FIG. 5 illustrates a mobile-terminated server according to an example embodiment of the present invention;

FIG. 6 illustrates processing operations of packet mobile-terminated calls using dynamic IP according to an example embodiment of the present invention;

FIG. 7 is a flow chart showing processing operations of a mobile-terminated server in processing packet mobile-terminated calls using dynamic IP according to an example embodiment of the present invention; and

FIG. 8 is a flow chart showing processing operations of a mobile-terminated GGSN and GGSN in processing packet mobile-terminated calls using dynamic IP according to an example embodiment of the present invention.

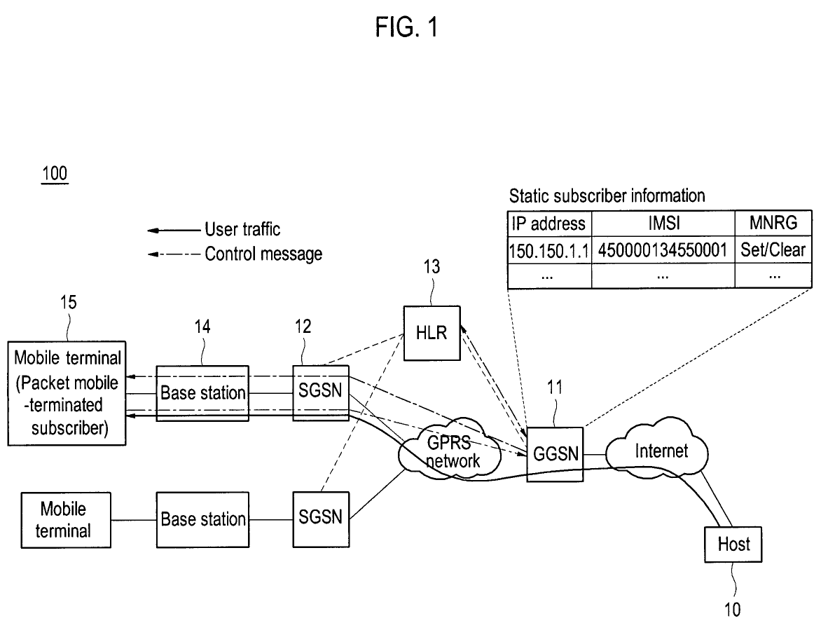

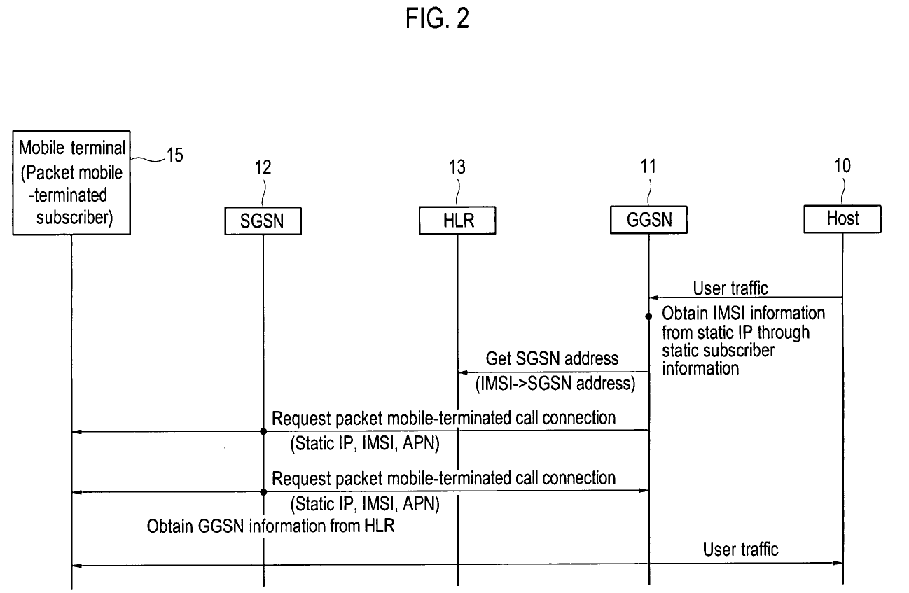

### DETAILED DESCRIPTION

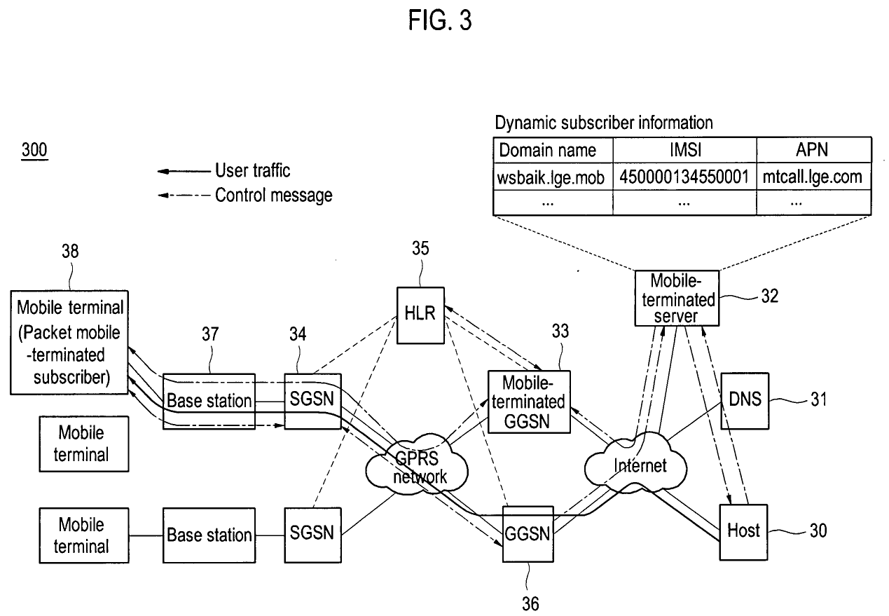

FIG. 3 illustrates a system for processing packet mobile-terminated calls using dynamic IP in a next-generation radio packet service network according to an example embodiment of the present invention. Other embodiments and configurations are also within the scope of the present invention.

More specifically, FIG. 3 shows that a system 300 for processing packet mobile-terminated calls may include an Internet host 30, a Domain Name Server (DNS) 31, a mobile-terminated server 32, a mobile-terminated GGSN 33, a SGSN 34, a HLR 35, a GGSN 36, a base station 37 and a mobile terminal (or a packet mobile-terminated subscriber) 38.

The DNS 31 may deliver a DNS query received as a domain name conversion request from the Internet host 30 to the mobile-terminated server 32. The mobile-terminated server 32 may search for dynamic subscriber information based on a domain name included in the DNS query received from the DNS 31. The mobile-terminated server 32 may retrieve IMSI and APN information, which are identification information for a mobile-terminated subscriber, and then request initiation of a packet mobile-terminated call connection and IP resolve to the GGSN 36 acting as a mobile-terminated gateway. After establishing the packet call connection, the mobile-terminated server 32 may register the dynamic IP assigned to the packet mobile-terminated subscriber 38 to the dynamic subscriber information in a conversion database (DB). The mobile-terminated server 32 may then deliver the dynamic IP information of the packet mobile-terminated subscriber 38 to the host 30, which has transmitted the corresponding DNS query through the DNS 31.

The mobile-terminated GGSN 33 may use the IMSI information (i.e., identification information for a packet mobile-terminated subscriber) received from the mobile-terminated server 32 when the mobile-terminated server 32 requests initiation of the packet mobile-terminated call connection and IP resolve for the packet mobile-terminated subscriber 38. Using the IMSI information, the mobile-terminated GGSN 33 may obtain address information of the SGSN 34 where the corresponding packet mobile-terminated subscriber 38 is located. This may be obtained from the HLR 35. The mobile-terminated GGSN 33 may request initiation of the packet mobile-terminated call connection to the corresponding SGSN 34 by adding address information of the mobile-terminated server 32 with the IMSI and APN information to a Protocol Configuration Option (PCO) field. According to the mobile-terminated request of the mobile-terminated GGSN 33, the SGSN 34 may request initiation of the packet mobile-terminated call connection by delivering the IMSI and APN information and the address information of the mobile-terminated server 32, which are received from the mobile-terminated GGSN 33, to the mobile terminal of the mobile-terminated packet subscriber 38.

During operations of the packet call connection for the packet mobile-terminated subscriber 38, the SGSN 34 may select the GGSN 36 to establish the packet mobile-terminated call using the APN information. The SGSN 34 may then request establishment of a session connection for the packet mobile-terminated call connection by delivering the IMSI and APN information of the packet mobile-terminated subscriber 38 and the address information of the mobile-terminated server 32 to the corresponding GGSN 36. The HLR 35 may manage information of a subscriber's location and subscription. According to the request of the SGSN 34 for establishment of a session connection for the packet mobile-terminated service, the GGSN 36 may assign dynamic IP to the packet mobile-terminated subscriber 38 and establish a session. Then, the GGSN 36 may transmit the dynamic IP assigned to the packet mobile-terminated subscriber 38 to the mobile-terminated server 32 and deliver subscriber traffic received from the Internet host 30 to the SGSN 34 and the base station 37. The base station 37 may deliver data to the mobile terminal 38 and manage radio resources. The mobile terminal 38 may be used by the subscriber to receive the radio packet data service.

The mobile-terminated GGSN 33 and the GGSN 36 may be logical divided so as to help explain features of embodiments of the present invention. The GGSN 33 and the GGSN 36 may be implemented as one GGSN or as different GGSNs.

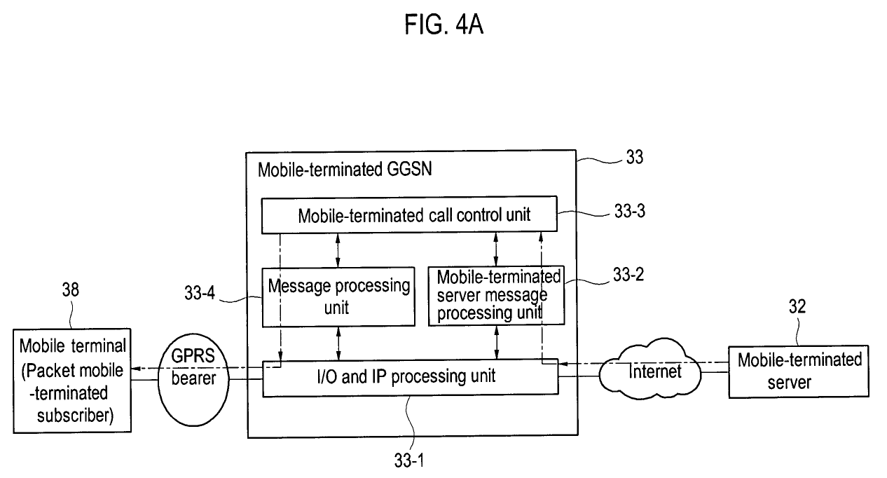

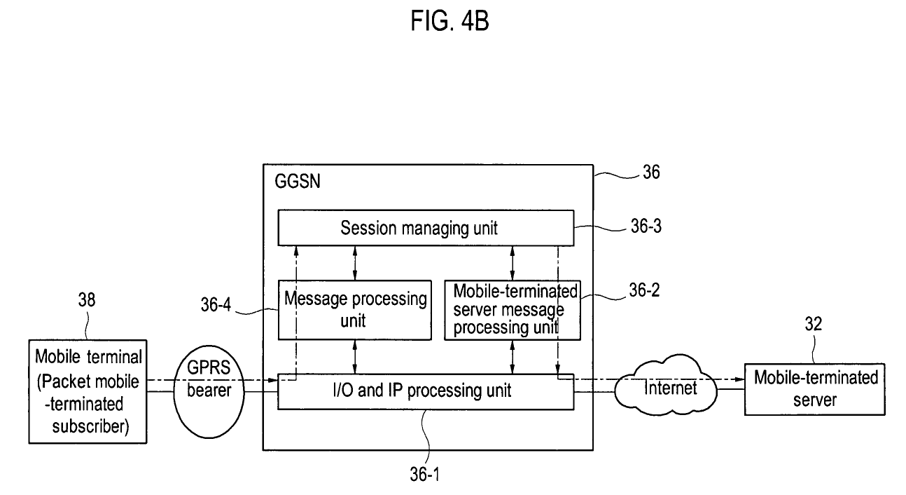

FIGS. 4A and 4B illustrate a mobile-terminated GGSN and a GGSN according to an example embodiment of the present invention. Other embodiments and configurations are also within the scope of the present invention. As shown in FIG. 4A, the mobile-terminated GGSN 33 may include an I/O and IP processing unit 33-1, a mobile-terminated server message processing unit 33-2, a mobile-terminated call control unit 33-3 and a message processing unit 33-4.

The I/O and IP processing unit 33-1 may perform internetworking and routing. The mobile-terminated server message processing unit 33-2 may process messages sent and received for interaction with the mobile-terminated server 32. The sent messages may include messages requesting initiation of a packet mobile-terminated call connection and IP resolve, messages requesting registration of dynamic IP, etc. The mobile-terminated call control unit 33-3 may search for a location of the packet mobile-terminated subscriber 38 from the HLR 35 by using identification information of the packet mobile-terminated subscriber included in messages received from the mobile-terminated server message processing unit 33-2. The mobile-terminated call control unit 33-3 may obtain address information of the SGSN where the packet mobile-terminated subscriber 38 is located and control the packet mobile-terminated call using dynamic IP. The message processing unit 33-4 may process messages of the packet mobile-terminated request for processing the packet mobile-terminated call.

As shown in FIG. 4B, the GGSN 36 may include a I/O and IP processing unit 36-1, a mobile-terminated server message processing unit 36-2, a session managing unit 36-3 and a message processing unit 36-4. The I/O and IP processing unit 36-1 may perform internetworking and routing. The mobile-terminated server message processing unit 36-2 may process messages sent and received for interaction with the mobile-terminated server 32. The sent messages may include messages requesting initiation of a packet mobile-terminated call connection and IP resolve, messages requesting registration of dynamic IP, etc. The session managing unit 36-3 may assign dynamic IP to the packet mobile-terminated subscriber 38 according to a request of session connection. The session managing unit 36-3 may perform a series of management functions for registration of the assigned dynamic IP to the mobile-terminated server 32. The message processing unit 36-4 may process messages requesting connection establishment for processing the packet mobile-terminated call. In FIGS. 4A-4B, a GPRS bearer may represent a node or nodes (i.e., a base station, a base station controller, a SGSN, etc.) for providing radio packet service.

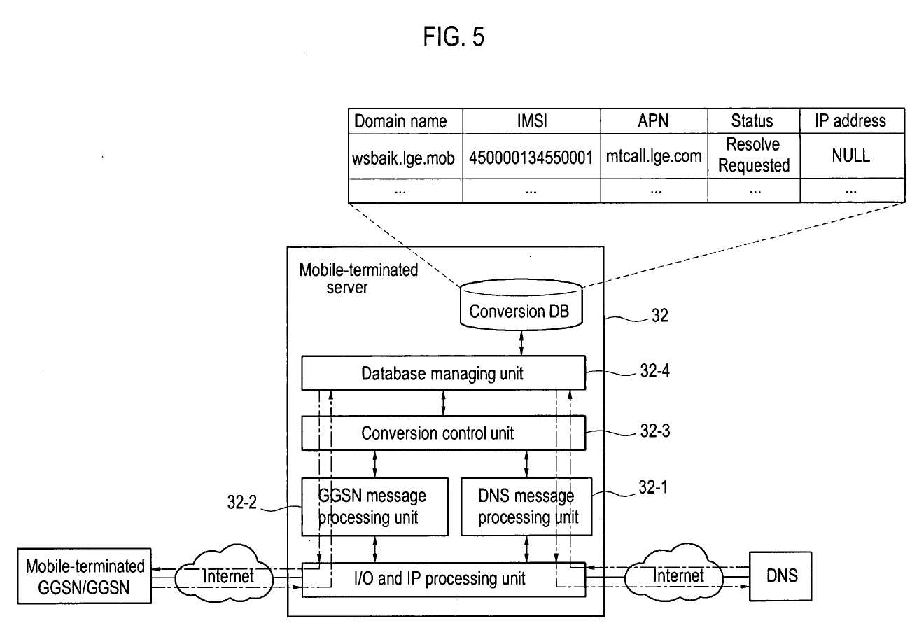

FIG. 5 illustrates a mobile-terminated server according to an example embodiment of the present invention. Other embodiments and configurations are also within the scope of the present invention. More specifically and as shown in FIG. 5, the mobile-terminated server 32 may include an I/O processing unit (unnumbered), a DNS message processing unit 32-1, a GGSN message processing unit 32-2, a conversion control unit 32-3 and a database managing unit 32-4. The DNS message processing unit 32-1 may process messages (e.g. DNS query message, response message, etc.) sent and received for interaction with the DNS 31. The GGSN message processing unit 32-2 may process messages sent and received for interaction with the GGSN 36. The sent messages may include messages requesting initiation of packet mobile-terminated call connection and IP resolve, messages requesting registration of dynamic IP, etc. The conversion control unit 32-3 may manage dynamic subscriber information in a conversion database (DB) through the database managing unit 32-4 and may manage and perform functions for converting a domain name of the packet mobile-terminated subscriber 38 to a dynamic IP address based on the dynamic subscriber information in the conversion DB. The conversion DB may be a database for saving dynamic subscriber information used in the conversion of a domain name to a dynamic IP address (i.e., a domain name), information of IMSI, APN, status, IP address, etc.

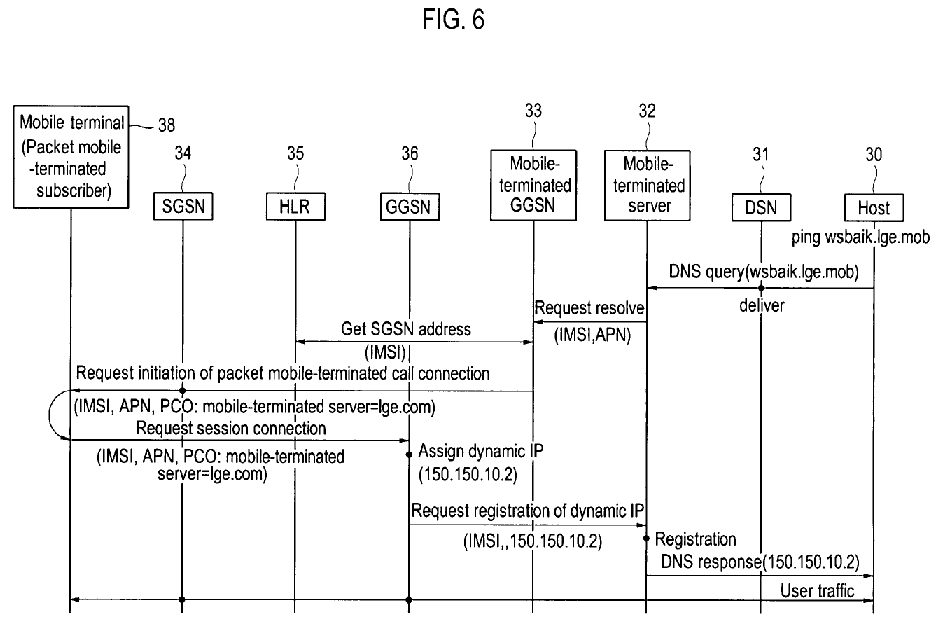

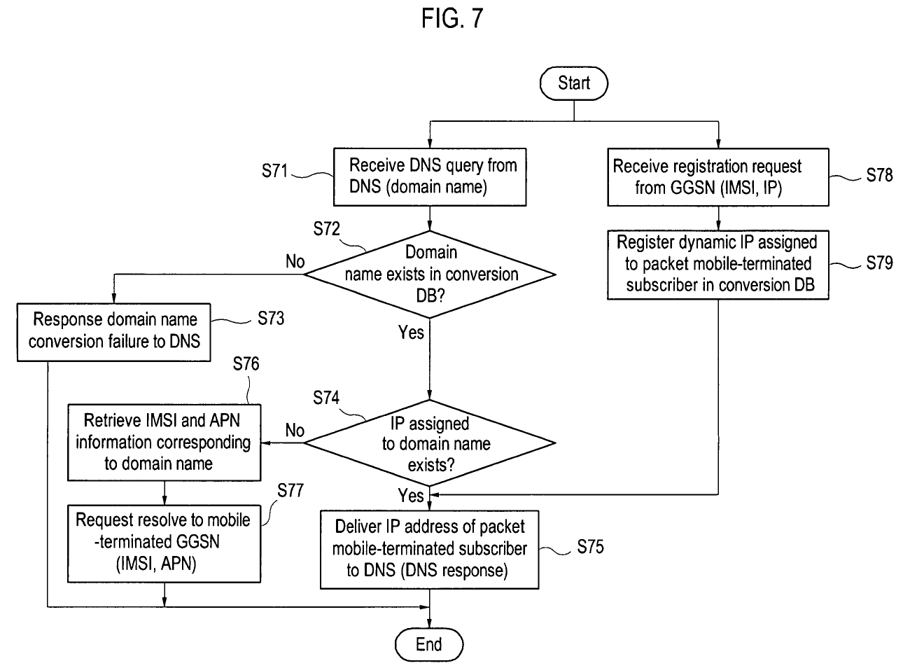

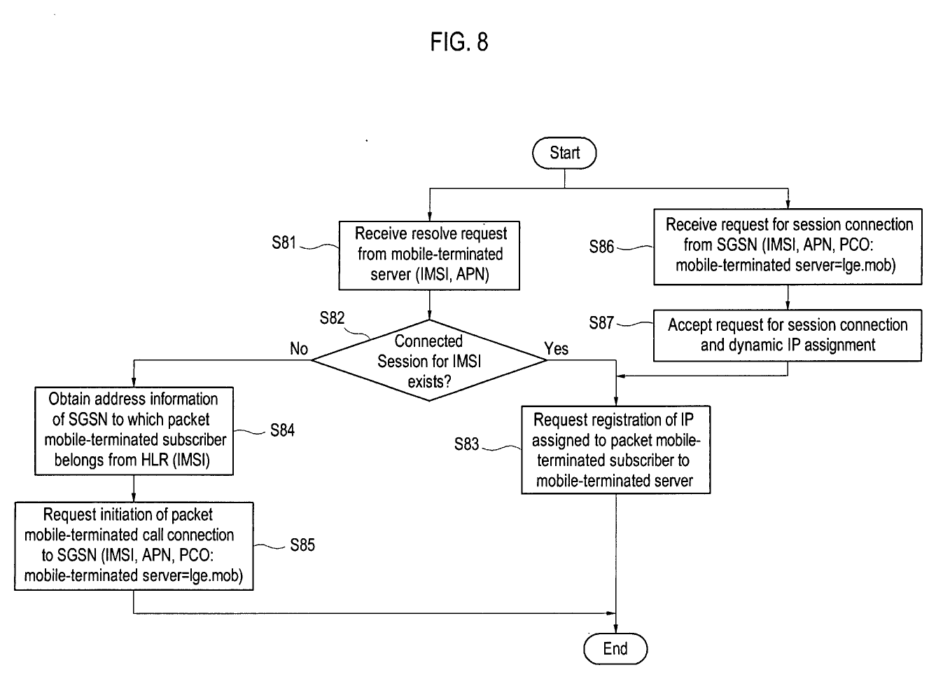

FIGS. 6 to 8 illustrate processing operations of packet mobile-terminated calls using dynamic IP in a next-generation radio packet service network according to example embodiments of the present invention. More specifically, FIG. 6 illustrates processing operations of packet mobile-terminated calls using dynamic IP according to an example embodiment of the present invention. FIG. 7 is a flow chart showing processing operations of a mobile-terminated server in processing packet mobile-terminated calls using dynamic IP according to an example embodiment of the present invention. FIG. 8 is a flow chart showing processing operations of a mobile-terminated GGSN and GGSN in processing the packet mobile-terminated calls using dynamic IP according to an example embodiment of the present invention. Other operations, orders of operations, configurations and embodiments are also within the scope of the present invention.

The Internet host 30, which is to transmit packet data to the packet subscriber using the mobile terminal 38, may transmit a DNS query to obtain an IP address corresponding to the domain name of the corresponding mobile packet subscriber. The DNS 31 may deliver the DNS query including the domain name to the mobile-terminated server 32.

In operation S71, the mobile-terminated server 32 may receive the DNS query including the domain name from the DNS 31. In operation S72, the mobile-terminated server 32 may determine whether a corresponding domain name exists by searching for dynamic subscriber information in the conversion DB based on domain name information included in the DNS query. When the domain name does not exist, the mobile-terminated server 32 may respond that the domain name does not exist (i.e., domain name conversion failed) to the DNS 31 in operation S73.

However, when the domain name of the corresponding packet mobile-terminated subscriber 38 exists as a result of searching dynamic subscriber information in the conversion DB, the mobile-terminated server 32 may determine whether an IP address assigned to the domain name exists in operation S74. When an IP address assigned to the domain name exists in operation S74 (i.e., the packet mobile-terminated subscriber 38 has already been assigned with an IP address for other packet service), the mobile-terminated server 32 may deliver the IP address of the corresponding packet mobile-terminated subscriber 38 to the DNS 31 in operation S75 as a response to the DNS query. Then, through the DNS 31, the IP address may be delivered to the Internet host 30, which is to transmit packet data to the corresponding packet mobile-terminated subscriber 38.

When an IP address assigned to the domain name does not exist in operation S74, then the mobile-terminated server 32 may retrieve IMSI information (i.e., identification information of the subscriber corresponding to the domain name of the packet mobile-terminated subscriber 38) and APN information for selecting the SGSN 34 in operation S76. In operation S77, the mobile-terminated server 32 may request initiation of the packet mobile-terminated call connection and IP resolve by transmitting the retrieved IMSI and APN information to the mobile-terminated GGSN 33, which acts as a mobile-terminated gateway.

The mobile-terminated GGSN 33 may receive the request for initiation of the packet mobile-terminated call connection and IP resolve from the mobile-terminated server 32 in operation S81. In operation S82, the mobile-terminated GGSN 33 may determine whether a connected session exists for the IMSI information of the packet mobile-terminated subscriber 38, which is received when the resolve is requested (i.e., whether the packet mobile-terminated subscriber 38 is in packet service). When a connected session for the IMSI information of the packet mobile-terminated subscriber 38 exists, the mobile-terminated GGSN 33 may request registration of the IP address assigned to the packet mobile-terminated subscriber 38 by transmitting the IP address and the IMSI information of the packet mobile-terminated subscriber 38 to the mobile-terminated server 32 in operation S83.

When it is determined that a connected session for the IMSI information of the packet mobile-terminated subscriber 38 does not exist in operation S82, the operation may include transmitting the IMSI information (e.g., subscriber identification information of the packet mobile-terminated subscriber 38) to the HLR 35. The mobile-terminated GGSN 33 may receive address information of the SGSN where the corresponding packet mobile-terminated subscriber 38 is located in operation S84. Using the received SGSN address information, the mobile-terminated GGSN 33 may request initiation of the packet mobile-terminated call connection to the corresponding SGSN 34. At that time, the mobile-terminated GGSN 33 may transmit the address information of the mobile-terminated server 32 to the SGSN 34 with the IMSI and APN information of the packet mobile-terminated subscriber 38 by adding to a PCO field in operation S85 since the GGSN 36 on which an actual packet mobile-terminated call is established may know whether the corresponding packet mobile-terminated call is transmitted or received and information for additional features after packet mobile-terminated call establishment.

The SGSN 34 may request initiation of the packet mobile-terminated call connection by transmitting the IMSI and APN information and the address information of the mobile-terminated server 32, received from the mobile-terminated GGSN 33, to the mobile terminal 38 of the corresponding packet mobile-terminated subscriber through the base station 37. The packet mobile-terminated subscriber 38 that requested the mobile-terminated call connection may request packet connection establishment by transmitting the information (IMSI, APN, PCO: mobile-terminated server=lge.mob) that are received through the SGSN 34 to the SGSN 34. The SGSN 34 may select the GGSN 36 to which actual user traffic is transmitted based on the APN information according to procedures of requesting dynamic call connection establishment. It may then request a session connection for packet mobile-terminated call establishment delivering the IMSI and APN information of the packet mobile-terminated subscriber 38 and the address information of the mobile-terminated server 32 to the corresponding GGSN 36.

When the GGSN 36 receives a request for session connection for the packet mobile-terminated call connection from the SGSN 34 in operation S86, the GGSN 36 may establish the packet mobile-terminated call session for user traffic transmission by assigning dynamic IP to the packet mobile-terminated subscriber 38 and allowing the request of session connection in operation S87. The GGSN 36 may then request registration of the IP address assigned to the corresponding packet mobile-terminated subscriber 38 by transmitting the assigned IP and IMSI information to the mobile-terminated server 32 in operation S83.

When the mobile-terminated server 32 receives a request for registration of IP information from the GGSN 36 in operation S78, using the received IMSI and dynamic IP information, the mobile-terminated server 32 may register the dynamic IP assigned to the corresponding packet mobile-terminated subscriber 38 to dynamic subscriber information in the conversion DB in operation S79. Then, the mobile-terminated server 32 may transmit the IP address to the DNS 31 in response to the DNS query in operation 75. Thereafter, the DNS 31 may deliver the IP address to the host 30 that transmitted the DNS query. Accordingly, the host 30 may transmit user traffic to the mobile terminal of the packet mobile-terminated subscriber 38 using the corresponding dynamic IP.

Embodiments of the present invention may provide a system and a method for assigning dynamic IP (not static IP) to mobile terminals and providing packet mobile-terminated call service using dynamic IP in a next-generation radio packet service network.

Embodiments of the present invention may provide packet mobile-terminated call service using dynamic IP in a next-generation radio packet service network by which IP resources are not dissipated as compared to using static IP. Management of information for a packet service subscriber may be facilitated by which cost of service may be reduced.

Embodiments of the present invention may assign dynamic IP based on a domain name of a mobile terminal in providing radio packet mobile-terminated service using dynamic IP. Thus, the radio packet service may be used by the domain name, which may be easier to remember than a static IP address. Further, the packet service subscriber may be provided with more reliable radio packet service.

According to an example embodiment of the present invention, a system may be provided for processing packet mobile-terminated calls from an Internet host to a mobile terminal in a radio packet service network. The system may include a Domain Name Server (DNS), a mobile-terminated server, a mobile-terminated GGSN, a SGSN and a GGSN. The DNS may process a domain name conversion request from the Internet host. The mobile-terminated server may retrieve International Mobile System Identifier (IMSI) and Access Point Name (APN) information of a packet mobile-terminated subscriber by searching for dynamic subscriber information in a conversion database (DB) based on a domain name included in a DNS query received from the DNS. The mobile-terminated server may further request initiation of packet mobile-terminated call connection and IP resolve to the mobile-terminated Gateway GPRS Support Node (GGSN). Still further, the mobile-terminated server may register an IP address assigned to the packet mobile-terminated subscriber as dynamic subscriber information in the conversion DB and transmit the IP address to the DNS.

The mobile-terminated GGSN may obtain address information of the Serving GPRS Support Node (SGSN) from a Home Location Register (HLR) by using IMSI information of the packet mobile-terminated subscriber and request initiation of the packet mobile-terminated call connection by transmitting the IMSI and APN information and the address information of the mobile-terminated server. The packet mobile-terminated subscriber may belong to the SGSN. The IMSI and APN information may be received when the mobile-terminated server requests initiation of the packet mobile-terminated call connection and IP resolve.

The SGSN may request initiation of the packet mobile-terminated call connection by transmitting the IMSI and APN information and the address information of the mobile-terminated server to a mobile terminal of the packet mobile-terminated subscriber. The SGSN may select the GGSN for establishing the packet mobile-terminated call by using the APN information and request establishment of the session connection for the packet mobile-terminated call connection by transmitting the IMSI and APN information of the packet mobile-terminated subscriber and the address information of the mobile-terminated server to the selected GGSN. The IMSI and APN information and the address information of the mobile-terminated server may be received from the mobile-terminated GGSN.

The GGSN may establish a session and assign an IP address to the packet mobile-terminated subscriber according to the request for the session connection establishment from the SGSN. The GGSN may transmit the assigned IP address to the mobile-terminated server and transmit user traffic received from the Internet host to the packet mobile-terminated subscriber through the SGSN and a base station.

The mobile-terminated GGSN may include: an I/O and IP processing unit, a mobile-terminated server message processing unit, a mobile-terminated call control unit and a message processing unit. The I/O and IP processing unit may perform internetworking and routing. The mobile-terminated server message processing unit may receive and process messages requesting initiation of the packet mobile-terminated call connection and IP resolve. The messages may be received from the mobile-terminated server. The mobile-terminated call control unit may obtain the corresponding SGSN address by retrieving a location of the packet mobile-terminated subscriber from the HLR by using identification information of the packet mobile-terminated subscriber. The identification information may be included in a message received from the mobile-terminated server message processing unit. The message processing unit may transmit a message requesting initiation of the packet mobile-terminated call connection to the SGSN through the I/O and IP processing unit.

The GGSN may include an I/O and IP processing unit, a message processing unit, a session managing unit and a mobile-terminated server message processing unit. The I/O and IP processing unit may perform internetworking and routing. The message processing unit may receive and process a message requesting a session connection. The message may be received from the SGSN through the I/O and IP processing unit. The session managing unit may assign an IP address to the packet mobile-terminated subscriber according to the message requesting the session connection. Still further, the session managing unit may establish the packet mobile-terminated call session, transmit the assigned IP address with the IMSI information to the mobile-terminated server and request registration. The mobile-terminated server message processing unit may process and transmit a message requesting IP address registration to the mobile-terminated server.

The mobile-terminated server may include a DNS message processing unit, a GGSN message processing unit, a conversion control unit and a database managing unit. The DNS message processing unit may process messages of the DNS query and the response. The GGSN message processing unit may process messages requesting initiation of the packet mobile-terminated call connection, the IP resolve and the IP address registration. The conversion control unit may manage dynamic subscriber information in the conversion DB through the database managing unit, and manage and perform functions for converting the domain name of the packet mobile-terminated subscriber to an IP address based on the dynamic subscriber information in the conversion DB.

The dynamic subscriber information in the conversion DB may include a domain name of the packet service subscriber, information of the IMSI, the APN, the status and the assigned IP address.

A method may be provided for processing packet mobile-terminated calls from an Internet host to a mobile terminal in a radio packet service network. The method may include at the Internet host, transmitting a DNS query to obtain an IP address corresponding to a domain name of a packet mobile-terminated subscriber to which a packet data is transmitted.

Additionally, at a mobile-terminated server, the method may include retrieving IMSI and APN information of the packet mobile-terminated subscriber by searching for dynamic subscriber information in a conversion DB based on a domain name included in the DNS query. The method may further include requesting initiation of the packet mobile-terminated call connection and IP resolve by transmitting the IMSI and APN information to a mobile-terminated GGSN.

The method may also include the mobile-terminated GGSN requesting initiation of the packet mobile-terminated call connection by transmitting the IMSI and APN information of the packet mobile-terminated subscriber and the address information of the mobile-terminated server to a SGSN. The packet mobile-terminated subscriber may belong to the SGSN.

Still further, the method may include the SGSN performing procedures for the packet mobile-terminated call connection between the packet mobile-terminated subscriber and a GGSN by using the IMSI and APN information and the address information of the mobile-terminated server. User traffic may be transmitted to the GGSN. The IMSI and APN information and the address information may be received from the mobile-terminated GGSN.

Additionally, the method may also include the GGSN assigning an IP address to the packet mobile-terminated subscriber, establishing a session for the packet mobile-terminated call and requesting registration of the assigned IP address to the mobile-terminated server. The method may also include the mobile-terminated server registering the IP address assigned to the packet mobile-terminated subscriber as dynamic subscriber information in the conversion DB and transmitting the registered IP address to the Internet host through a DNS so that user traffic may be transmitted by using the registered IP address.

The method may further include the mobile-terminated server searching for dynamic subscriber information in the conversion DB by using the domain name information included in the DNS query, and when there is an IP address assigned to the domain name, transmitting the IP address to the Internet host without requesting IP resolve to the mobile-terminated GGSN.

The method may further include the mobile-terminated GGSN determining whether there is a connected session for the IMSI information of the packet mobile-terminated subscriber, and when there is a connected session for the IMSI information of the packet mobile-terminated subscriber, requesting registration of assigned IP address information by transmitting the IP address information assigned to the packet mobile-terminated subscriber and the IMSI information of the packet mobile-terminated subscriber to the mobile-terminated server. The IMSI information may be received when the mobile-terminated server requests initiation of the packet mobile-terminated call connection and IP resolve.

The requested initiation of the packet mobile-terminated call connection to the SGSN may include transmitting the IMSI information of the packet mobile-terminated subscriber to the HLR, wherein the IMSI information is received when the mobile-terminated server requests initiation of the packet mobile-terminated call connection and IP resolve. The requested initialization of the packet mobile-terminated call connection may also include receiving address information of the SGSN where the packet mobile-terminated subscriber is located and requesting initiation of the packet mobile-terminated call connection to the SGSN corresponding to the received SGSN address information.

The performing procedures for the packet mobile-terminated call connection between the packet mobile-terminated subscriber and the GGSN may include the SGSN requesting initiation of the packet mobile-terminated call connection by transmitting the IMSI and APN information and the address information of the mobile-terminated server received from the mobile-terminated GGSN to the mobile terminal of the corresponding packet mobile-terminated subscriber through the base station. The performing procedures may also include in the packet mobile-terminated subscriber that received the request for initiation of the packet mobile-terminated call connection, requesting packet connection establishment by transmitting the received IMSI and APN information and the address information of the mobile-terminated server to the SGSN. The performing procedures may further include in the SGSN selecting the GGSN for transmitting user traffic based on the APN information according to the procedure of requesting dynamic call connection establishment, and requesting the session connection for the packet mobile-terminated call establishment by transmitting the IMSI and APN information of the packet mobile-terminated subscriber and the address information of the mobile-terminated server to the selected GGSN.

Any reference in this specification to “one embodiment,” “an embodiment,” “example embodiment,” etc., means that a particular feature, structure, or characteristic described in connection with the embodiment is included in at least one embodiment of the present invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A system for processing packet mobile-terminated calls in a radio packet service network, the system comprising:
a Domain Name Server (DNS) to process a domain name conversion request;
a mobile-terminated server to search dynamic subscriber information in a database based on a domain name included in a DNS query received from the DNS and to retrieve International Mobile System Identifier (IMSI) and Access Point Name (APN) information of a packet mobile-terminated subscriber, the mobile-terminated server to further register an IP address assigned to the packet mobile-terminated subscriber as dynamic subscriber information in the database;
a mobile-terminated GGSN to obtain address information of a Serving GPRS Support Node (SGSN) from a Home Location Register (HLR) based on the IMSI information and to transmit the IMSI and APN information and address information of the mobile-terminated server;
a SGSN to transmit the IMSI and APN information and the address information of the mobile-terminated server to a mobile terminal of the packet mobile-terminated subscriber, the SGSN to select a GGSN for establishing the packet mobile-terminated call based on the APN information and to transmit the IMSI and APN information of the packet mobile-terminated subscriber and the address information of the mobile-terminated server to the selected GGSN to request establishment of a session connection for the packet mobile-terminated call connection; and
a GGSN to assign the IP address to the packet mobile-terminated subscriber based on the request for the session connection establishment from the SGSN, the GGSN to transmit the assigned IP address to the mobile-terminated server.

2. The system of claim 1, wherein the mobile-terminated GGSN includes:
an I/O and IP processing unit to perform internetworking and routing;
a mobile-terminated server message processing unit to receive and process messages from the mobile-terminated server requesting initiation of the packet mobile-terminated call connection and IP resolve;
a mobile-terminated call control unit to retrieve a location of the packet mobile-terminated subscriber from the HLR using identification information of the packet mobile-terminated subscriber and to obtain a corresponding SGSN address; and
a message processing unit to transmit a message requesting initiation of the packet mobile-terminated call connection to the SGSN through the I/O and IP processing unit.

3. The system of claim 1, wherein the GGSN comprises:
an I/O and IP processing unit to perform internetworking and routing;
a message processing unit to receive and process a message from the SGSN requesting session connection;
a session managing unit to assign the IP address to the packet mobile-terminated subscriber according to the message requesting the session connection, and to transmit the assigned IP address with the IMSI information to the mobile-terminated server; and
a mobile-terminated server message processing unit to transmit a message requesting IP address registration to the mobile-terminated server.

4. The system of claim 1, wherein the mobile-terminated server includes:
a DNS message processing unit to process query messages and response messages;
a GGSN message processing unit to process messages requesting initiation of the packet mobile-terminated call connection and IP address registration; and
a conversion control unit to manage dynamic subscriber information in the database and to convert the domain name of the packet mobile-terminated subscriber to the IP address based on the dynamic subscriber information in the database.

5. The system of claim 1, wherein the dynamic subscriber information in the database includes a domain name of the packet service subscriber, IMSI information, APN information, status information and assigned IP address information.

6. A system comprising:
a Domain Name Server (DNS) to process a domain name request;
a mobile-terminated server to search dynamic subscriber information based on a domain name included in a received DNS query, the mobile-terminated server to retrieve information of a packet mobile-terminated subscriber, the mobile-terminated server to further register an IP address assigned to the packet mobile-terminated subscriber as dynamic subscriber information and to transmit the IP address to the DNS;
a first GGSN to obtain address information of node from a Home Location Register (HLR) based on the information of the packet mobile-terminated subscriber and to transmit the information and address information of the mobile-terminated server;
a SGSN to transmit the information and the address information of the mobile-terminated server to a mobile terminal of the packet mobile-terminated subscriber, the SGSN to select a GGSN for establishing a packet mobile-terminated call based on the information and to transmit the information of the packet mobile-terminated subscriber and the address information of the mobile-terminated server to the selected GGSN; and
a second GGSN to establish a session and assign the IP address to the packet mobile-terminated subscriber, the second GGSN to transmit the assigned IP address to the mobile-terminated server and to transmit user traffic received from an Internet host to the packet mobile-terminated subscriber.

7. The system of claim 6, wherein the information includes an International Mobile System Identifier (IMSI) and an Access Point Name (APN).

8. The system of claim 6, wherein the first GGSN includes:
an I/O and IP processing unit;
a mobile-terminated server message processing unit to process messages requesting initiation of the packet mobile-terminated call connection and IP resolve;
a mobile-terminated call control unit to retrieve a location of the packet mobile-terminated subscriber from the HLR using the identification information of the packet mobile-terminated subscriber so as to obtain a SGSN address; and
a message processing unit to transmit a message requesting initiation of the packet mobile-terminated call connection to the SGSN through the I/O and IP processing unit.

9. The system of claim 6, wherein the second GGSN comprises:
an I/O and IP processing unit;
a message processing unit to process a message from the SGSN requesting session connection;
a session managing unit to assign the IP address to the packet mobile-terminated subscriber according to the message requesting the session connection, the session managing unit to establish the packet mobile-terminated call session, to transmit the assigned IP address with the IMSI information to the mobile-terminated server; and
a mobile-terminated server message processing unit to transmit a message requesting IP address registration to the mobile-terminated server.

10. The system of claim 6, wherein the mobile-terminated server includes:
a DNS message processing unit to process DNS query messages and response messages;
a GGSN message processing unit to process messages requesting initiation of the packet mobile-terminated call connection and IP address registration; and
a conversion control unit to manage dynamic subscriber information and to convert the domain name of the packet mobile-terminated subscriber to an IP address based on the dynamic subscriber information.

11. The system of claim 6, wherein the dynamic subscriber information includes a domain name of the packet service subscriber, IMSI information, APN information, and assigned IP address information.

12. The system of claim 6, wherein the first GGSN is different than the second GGSN.

13. The system of claim 6, wherein the first GGSN is the same as the second GGSN.

14. A method of processing packet mobile-terminated calls in a radio packet service network, comprising:
transmitting a DNS query to obtain an IP address corresponding to a domain name of a packet mobile-terminated subscriber;
at a mobile-terminated server, searching dynamic subscriber information in a database based on a domain name included in the DNS query so as to retrieve IMSI and APN information of the packet mobile-terminated subscriber and transmitting the IMSI and APN information to a mobile-terminated GGSN;
transmitting the IMSI and APN information of the packet mobile-terminated subscriber and address information of the mobile-terminated server from the mobile-terminated GGSN to a SGSN;
performing the packet mobile-terminated call connection at the SGSN between the packet mobile-terminated subscriber and a GGSN using the IMSI and APN information and the address information of the mobile-terminated server, wherein the IMSI and APN information and the address information are received from the mobile-terminated GGSN;
at the GGSN, assigning an IP address to the packet mobile-terminated subscriber, establishing a session for the packet mobile-terminated call and requesting registration of the assigned IP address; and
at the mobile-terminated server, registering the IP address assigned to the packet mobile-terminated subscriber as dynamic subscriber information in the database and transmitting the registered IP address to an Internet host so that user traffic may be transmitted using the registered IP address.

15. The method of claim 14, further comprising:
searching the dynamic subscriber information in the database using the domain name information included in the DNS query, and when an IP address assigned to the domain name exists, transmitting the IP address to the Internet host without requesting IP resolve.

16. The method of claim 14, further comprising:
determining whether a connected session for the IMSI information of the packet mobile-terminated subscriber exists, and when a connected session for the IMSI information of the packet mobile-terminated subscriber exists, transmitting information of an IP address assigned to the packet mobile-terminated subscriber and the IMSI information of the packet mobile-terminated subscriber to the mobile-terminated server to request registration of the IP address.

17. The method of claim 14, further comprising requesting initiation of the packet mobile-terminated call connection by:
transmitting the IMSI information of the packet mobile-terminated subscriber to the HLR, wherein the IMSI information is received when the mobile-terminated server requests the initiation of the packet mobile-terminated call connection and IP resolve;
receiving the address information of the SGSN where the packet mobile-terminated subscriber is located; and
requesting initiation of the packet mobile-terminated call connection to the SGSN corresponding to the received SGSN address information.

18. The method of claim 14, wherein the performing procedures for packet mobile-terminated call connection between the packet mobile-terminated subscriber and a GGSN includes:
transmitting the IMSI and APN information and the address information of the mobile-terminated server received from the mobile-terminated GGSN to the mobile terminal of the corresponding packet mobile-terminated subscriber to request initiation of the packet mobile-terminated call connection;
at the packet mobile-terminated subscriber, transmitting the received IMSI and APN information and the address information of the mobile-terminated server to the SGSN to request the packet connection establishment; and
at the SGSN, selecting the GGSN for transmitting user traffic based on the APN information according to the requested dynamic call connection establishment and transmitting the IMSI and APN information of the packet mobile-terminated subscriber and the address information of mobile-terminated server to the selected GGSN to request session connection for packet mobile-terminated call establishment.

19. A method comprising:
searching dynamic subscriber information based on a domain name included in a DNS query to retrieve information of a packet mobile-terminated subscriber and transmitting the information to a mobile-terminated GGSN;
transmitting the information of the packet mobile-terminated subscriber and address information of the mobile-terminated server to a SGSN;
performing the packet mobile-terminated call connection between the packet mobile-terminated subscriber and a GGSN using the information and the address information of the mobile-terminated server;
assigning an IP address to the packet mobile-terminated subscriber and requesting registration of the assigned IP address; and
registering the IP address assigned to the packet mobile-terminated subscriber as dynamic subscriber information and transmitting the registered IP address to an Internet host so that user traffic may be transmitted using the registered IP address.

20. The method of claim 19, further comprising:
searching the dynamic subscriber information using the domain name included in the DNS query, and when the IP address assigned to the domain name exists, transmitting the IP address to the Internet host without requesting IP resolve.

21. The method of claim 19, further comprising:
determining whether a connected session for the information of the packet mobile-terminated subscriber exists, and when a connected session for the information of the packet mobile-terminated subscriber exists, transmitting information of the IP address assigned to the packet mobile-terminated subscriber and the information of the packet mobile-terminated subscriber to the mobile-terminated server to request registration of the IP address information.

22. The method of claim 19, wherein the requesting initiation of the packet mobile-terminated call connection to the SGSN includes:
transmitting the information of the packet mobile-terminated subscriber to a HLR;
receiving the address information of the SGSN where the packet mobile-terminated subscriber is located; and
requesting initiation of the packet mobile-terminated call connection to the SGSN corresponding to the received SGSN address information.

23. The method of claim 19, wherein the performing procedures for packet mobile-terminated call connection between the packet mobile-terminated subscriber and a GGSN includes:
transmitting the information and the address information of the mobile-terminated server received from the mobile-terminated GGSN to the mobile terminal of the corresponding packet mobile-terminated subscriber to request initiation of the packet mobile-terminated call connection;
transmitting the received information and the address information of the mobile-terminated server to the SGSN; and
selecting the GGSN for transmitting user traffic based on the information according to the procedure of requesting dynamic call connection establishment and transmitting the information of the packet mobile-terminated subscriber and the address information of mobile-terminated server to the selected GGSN.
